(19) United States
(12) Patent Application Publication
(10) Pub. No.: US 2011/0154484 A1
(43) Pub. Date: Jun. 23, 2011

(54) INFORMATION PROCESSING APPARATUS, METHOD OF CONTROLLING AUTHENTICATION PROCESS, AND RECORDING MEDIUM

(75) Inventor: Airi Shimabe, Kawasaki (JP)

(73) Assignee: FUJITSU LIMITED, Kawasaki-shi (JP)

(21) Appl. No.: 12/968,558

(22) Filed: Dec. 15, 2010

(30) Foreign Application Priority Data
Dec. 21, 2009 (JP) 2009-289239

(51) Int. Cl. G06F 9/00; H04L 9/32; G06F 21/00

(52) U.S. Cl. 726/19; 713/2

(57) ABSTRACT

An information processing apparatus includes, a determining unit to determine whether a boot trigger of a boot is power recovery, a memory to store count information indicating a skip count, a booting unit to skip an authentication process depending on a result of a determination by the determining unit and the count information to continue the boot; and an updating unit to update the count information when the authentication process is skipped.

### CROSS-REFERENCE TO RELATED APPLICATIONS

This application is based upon and claims the benefit of priority of the prior Japanese Patent Application No. 2009-289239, filed on Dec. 21, 2009, the entire contents of which are incorporated herein by reference.

### BACKGROUND

Some computers do not have drive batteries installed therein, for example, some desktop personal computers (PCs) have an automatic boot function when supply of operating power is restarted upon recovery from a power failure. The restart of supply of operating power upon recovery from the power failure is hereinafter referred to as “power recovery” and the above function is hereinafter referred to as an “AC recovery function.” The personal computers may be set so that an authentication process that is performed at normal boot is omitted (skipped) when the personal computers are booted in accordance with the AC recovery function. In a typical well-known authentication process, a user of a computer is prompted to input a password that is registered in advance. The password that is prompted to input is, for example, a so-called basic input/output system (BIOS) password, which is incorporated in the BIOS as part of its function (refer to Japanese Unexamined Patent Application Publication No. 2007-194989 and Japanese Unexamined Patent Application Publication No. 1992-054661).

### SUMMARY

According to an aspect of the invention, An information processing apparatus includes, a determining unit to determine whether a boot trigger of a boot is power recovery, a memory to store count information indicating a skip count, a booting unit to skip an authentication process depending on a result of a determination by the determining unit and the count information to continue the boot; and an updating unit to update the count information when the authentication process is skipped.

The object and advantages of the invention will be realized and attained at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of the configuration of an information processing apparatus according to an embodiment of the present invention;

FIG. 2 is a block diagram illustrating exemplary functions for setting authentication control information in the information processing apparatus according to the embodiment;

FIG. 3 is a block diagram illustrating exemplary functions at boot of the information processing apparatus according to the embodiment;

FIG. 4 illustrates an example of a user interface for prompting an operator to input information used for generating the authentication control information in the information processing apparatus according to the embodiment;

FIG. 5A illustrates an example of a process of generating the authentication control information in the information processing apparatus according to the embodiment;

FIG. 5B illustrates an example of a process of generating the authentication control information in the information processing apparatus according to the embodiment;

FIG. 6 illustrates exemplary information input by the operator in accordance with a user interface in the information processing apparatus according to the embodiment;

FIG. 7 illustrates exemplary reservation information stored at shutdown reservation in the information processing apparatus according to the embodiment;

FIG. 8 illustrates an example of a process of generating the authentication control information by using the reservation information in the information processing apparatus according to the embodiment;

FIG. 9 illustrates an example of an authentication control process at boot in the information processing apparatus according to the embodiment;

FIG. 10 illustrates an example of a process of generating and registering a skip key in the information processing apparatus according to the embodiment; and

FIG. 11 illustrates an example of the external view of the information processing apparatus according to the embodiment.

### DESCRIPTION OF EMBODIMENTS

Embodiments of the present invention will herein be described with reference to the attached drawings.

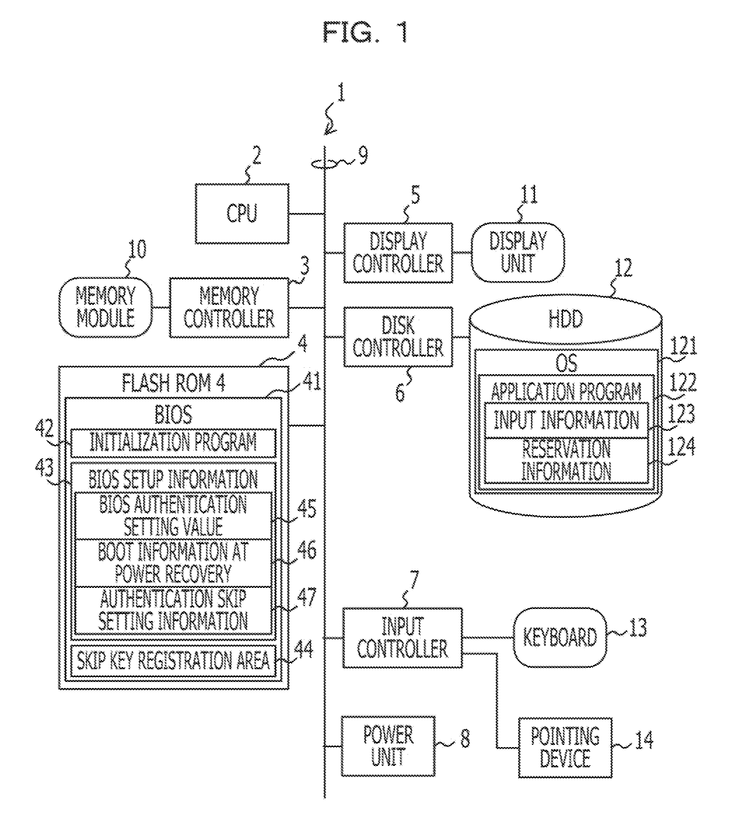

The configuration of an information processing apparatus according to an embodiment of the present invention will now be described with reference to FIG. 1. FIG. 1 is a block diagram illustrating an example of the configuration of an information processing apparatus 1 according to an embodiment of the present invention. Referring to FIG. 1, the information processing apparatus 1 includes a central processing unit (CPU) 2, a memory controller 3, a flash read only memory (ROM) 4, a display controller 5, a disk controller 6, an input controller 7, and a power unit 8 that are connected to each other via a bus 9. A memory module 10 is connected to the memory controller 3. A display unit 11 is connected to the display controller 5. A hard disk drive (HDD) 12 is connected to the disk controller 6. A keyboard 13 and a pointing device 14 are connected to the input controller 7.

The CPU 2 controls the entire operation of the information processing apparatus 1. The memory controller 3 reads data stored in the memory module 10 and writes data in the memory module 10 under the control of the CPU 2. The memory module 10 includes a volatile memory that holds the data. For example, a dynamic random access memory (DRAM) may be applied to the volatile memory. The flash ROM 4 is a rewritable non-volatile memory. The flash ROM 4 stores a BIOS 41. The BIOS 41 defines firmware for inputting and outputting data into and from the information processing apparatus 1. The BIOS 41 includes an initialization program 42 and BIOS setup information 43. A skip key registration area 44 in which a skip key is registered is provided in the BIOS 41. The initialization program 42 is executed upon turning on of the information processing apparatus 1. The initialization program 42 may be a Power On Self Test (POST) used in a Personal Computer-Advanced Technology (PC/AT) compatible machine. The initialization program 42 has a function of determining whether a boot trigger of the information processing apparatus 1 is the power recovery. The BIOS setup information 43 indicates settings of an initialization process and the hardware configuration. Such settings are held as parameters in the BIOS setup information 43. Part of such parameters may be set by an operator who operates the information processing apparatus 1. According to the present embodiment, the BIOS setup information 43 includes a BIOS authentication setting value 45, boot information at power recovery 46, and authentication skip setting information 47. The BIOS authentication setting value 45 is specific data used in an authentication process. A BIOS password is used in the BIOS authentication in the present embodiment. Accordingly, the BIOS authentication setting value 45 indicates a password that is referred to in the authentication in a setting to perform the BIOS authentication. If the BIOS authentication setting value 45 indicates a null character, the BIOS authentication process is not performed at boot in response to any trigger. The boot information at power recovery 46 indicates whether the system of the information processing apparatus 1 is automatically booted at power recovery. The authentication skip setting information 47 indicates whether the authentication process is skipped at power recovery boot. The skip key registered in the skip key registration area 44 is data that is referred to when the authentication process at power recovery is skipped. The skip key indicates the count of power recovery boot, in which the authentication process is skipped. According to the present embodiment, the skip key indicates the skip count that is equal to an integer from zero to nine. The boot of a computer in response to power recovery is referred to as the “boot at power recovery” and the state in which the computer is being booted in response to power recovery is referred to as “power recovery boot.” The skip key, the boot information at power recovery 46, and the authentication skip setting information 47 are collectively referred to as authentication control information in this specification.

The display controller 5 controls information displayed in the display unit 11 in accordance with an instruction from the CPU 2. The disk controller 6 controls the operation of the HDD 12 in accordance with an instruction from the CPU 2. The HDD 12 stores an operating system (OS) 121. The OS 121 provides an application program interface (API) or an application binary interface (ABI) to various application programs that are activated. An application program 122 concerning the control of the authentication process is activated in the OS 121. The application program 122 holds input information 123 that is input by the operator and reservation information 124 that is stored at reservation of shutdown. The operation of the information processing apparatus 1 in response to the application program 122 that is activated, the input information 123, and the reservation information 124 are described below. The input controller 7 receives an operation by the operator with the keyboard 13 or the pointing device 14 and notifies the CPU 2 of the operation. A mouse or a trackball may be applied to the pointing device 14. The power unit 8 is connected to an external power supply (outlet) (not illustrated) and supplies operation power to each component in the information processing apparatus 1 based on the power supplied from the external power supply. The power unit 8 may include a battery. The battery is used to supply power for keeping specified data when the power is turned off.

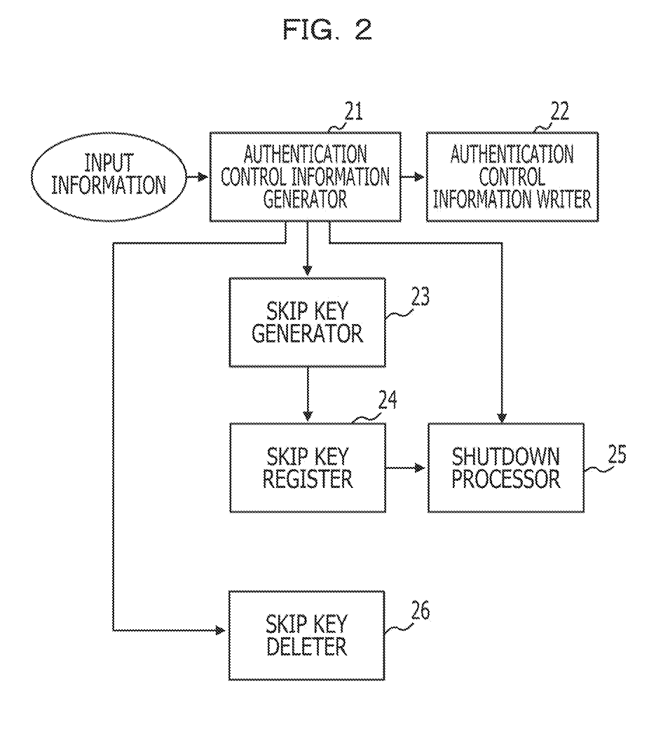

FIG. 2 is a block diagram illustrating exemplary functions for setting the authentication control information in the information processing apparatus 1. Referring to FIG. 2, an authentication control information generator 21 generates the authentication control information in response to an input operation by the operator described below. An authentication control information writer 22 writes the generated authentication control information in the flash ROM 4. For example, the authentication control information writer 22 writes the boot information at power recovery 46 and the authentication skip setting information 47 in the flash ROM 4. A skip key generator 23 generates the skip key, if needed, in the generation of the authentication control information by the authentication control information generator 21. A skip key register 24 registers the generated skip key in the BIOS 41 in the flash ROM 4. A shutdown processor 25 shuts down the information processing apparatus 1 in response to a notification from the authentication control information generator 21 or the skip key register 24. A skip key deleter 26 deletes the skip key stored in the flash ROM 4, if needed, in the generation of the authentication control information by the authentication control information generator 21.

The authentication control information generator 21, the authentication control information writer 22, the skip key generator 23, the skip key register 24, and the shutdown processor 25 are realized by the CPU 2 that executes the application program 122. In the execution of the application program 122, a memory space in the memory module 10 may be used.

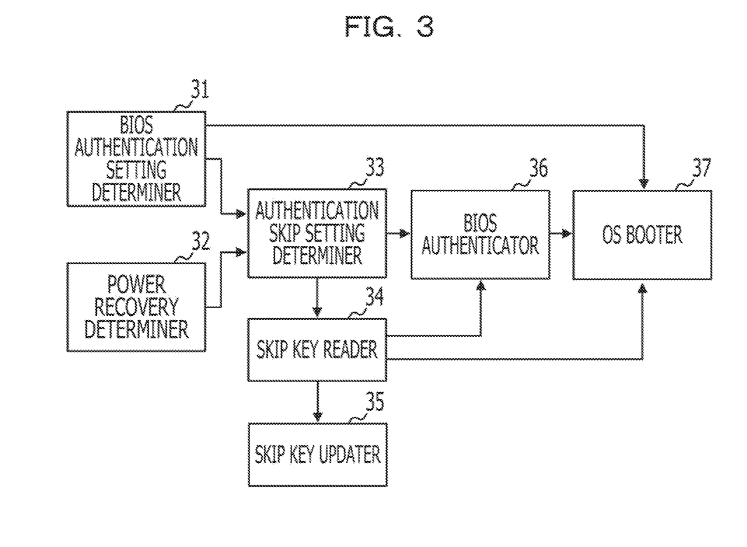

FIG. 3 is a block diagram illustrating exemplary functions at boot of the information processing apparatus 1. Referring to FIG. 3, a BIOS authentication setting determiner 31 determines whether the BIOS authentication is set to be performed at boot. In the determination, the BIOS authentication setting determiner 31 may refer to the BIOS authentication setting value 45 stored in the flash ROM 4. If the BIOS authentication is set to be performed at boot, the BIOS authentication setting determiner 31 notifies an authentication skip setting determiner 33 that the BIOS authentication is set to be performed at boot. If the BIOS authentication is not set to be performed at boot, the BIOS authentication setting determiner 31 instructs an OS booter 37 to boot the OS. A power recovery determiner 32 determines whether the boot trigger is the power recovery. In the determination, the power recovery determiner 32 may use the function of the initialization program 42. If the boot trigger is the power recovery, the power recovery determiner 32 notifies the authentication skip setting determiner 33 that the boot trigger is the power recovery.

The authentication skip setting determiner 33 determines whether information about an instruction to skip the BIOS authentication is set in response to the notifications from the BIOS authentication setting determiner 31 and the power recovery determiner 32. In the determination, the authentication skip setting determiner 33 may refer to the authentication skip setting information 47 stored in the flash ROM 4. If the information about the instruction to skip the BIOS authentication is set, the authentication skip setting determiner 33 notifies a skip key reader 34 that the information about the instruction to skip the BIOS authentication is set. The skip key reader 34 reads the skip key from the flash ROM 4 in response to the notification from the authentication skip setting determiner 33.

If the information about the instruction to skip the BIOS authentication is not set, the authentication skip setting determiner 33 instructs a BIOS authenticator 36 to perform the BIOS authentication. If the skip key read by the skip key reader 34 indicates zero, the skip key reader 34 notifies the BIOS authenticator 36 that the skip key indicates zero. The BIOS authenticator 36 performs the BIOS authentication process in response to the instruction to perform the BIOS authentication from the authentication skip setting determiner 33 or in response to the notification of the skip key indicating zero from the skip key reader 34. If the BIOS authentication process is successfully performed, the BIOS authenticator 36 notifies the OS booter 37 that the BIOS authentication process is successfully performed.

If the skip key indicates a value larger than or equal to one, the skip key reader 34 instructs the OS booter 37 to boot the OS. The skip key reader 34 substantially simultaneously instructs a skip key updater 35 to update the skip key. The skip key updater 35 updates the skip key so that the skip count indicated by the skip key is decremented by one in response to the instruction from the skip key reader 34.

The OS booter 37 performs a process to boot the OS of the information processing apparatus 1 in response to the instruction to boot the OS from the BIOS authentication setting determiner 31 or the skip key reader 34 or in response to the notification that the BIOS authentication process is successfully performed from the BIOS authenticator 36.

The BIOS authentication setting determiner 31, the power recovery determiner 32, the authentication skip setting determiner 33, the skip key reader 34, the skip key updater 35, the BIOS authenticator 36, and the OS booter 37 are realized by the CPU 2 that executes the initialization program 42 stored in the flash ROM 4. In the execution of the initialization program 42, a memory space in the memory module 10 may be used.

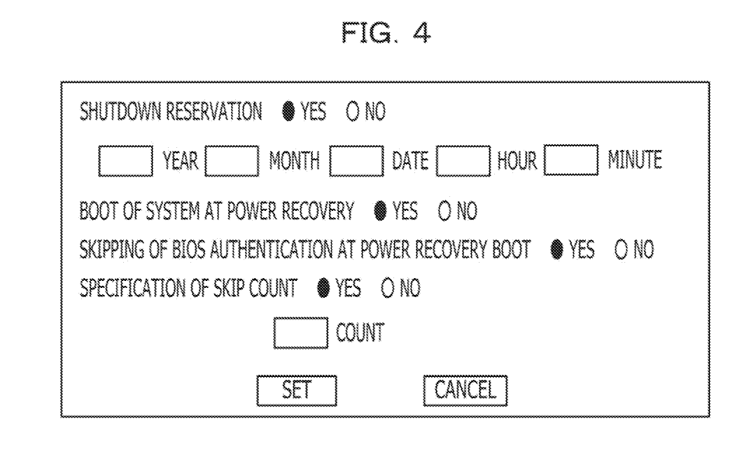

A process of generating and writing the authentication control information and the skip key will now be described with reference to FIGS. 4 to 8, in addition to FIG. 2 described above.

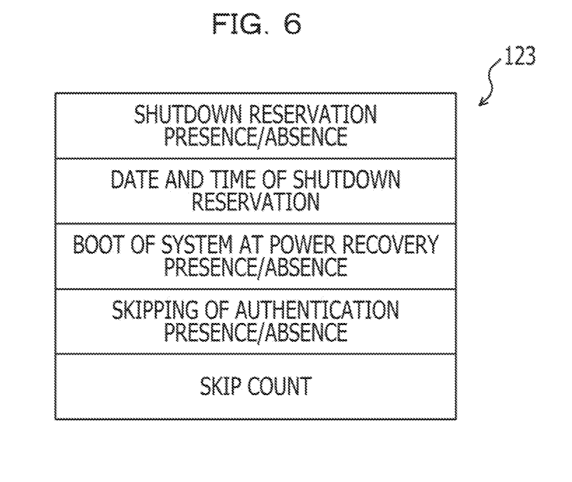

The CPU 2, which executes the application program 122 in response to an operation by the operator of the information processing apparatus 1, displays a user interface prompting the operator to input information used in the generation of the authentication control information and the skip key in the display unit 11. FIG. 4 illustrates an example of the user interface. The operator is prompted to input shutdown reservation of the information processing apparatus 1, automatic boot of the system at power recovery, skipping of the BIOS authentication at power recovery boot, and the skip count in the exemplary user interface in FIG. 4. The information processing apparatus 1 receives necessary information from the operator in accordance with the exemplary user interface in FIG. 4. For example, when a numerical value or instruction is input and a “Set” button is pressed (selected) by the operator, the input information 123 indicating the instruction input by the operator is temporarily held in the HDD 12 by the application program 122. The input information 123 indicates, for example, a variety of information illustrated in FIG. 6. For example, the input information 123 indicates the presence or absence of the shutdown reservation, the date and time of the shutdown reservation, the presence or absence of the boot of the system at power recovery, the presence or absence of the skipping of the authentication at power recovery boot, and the skip count. When the authentication process is skipped once at boot, the subsequent boot process is continued. Accordingly, the skip count is equal to the number of times when the authentication process is skipped at power recovery.

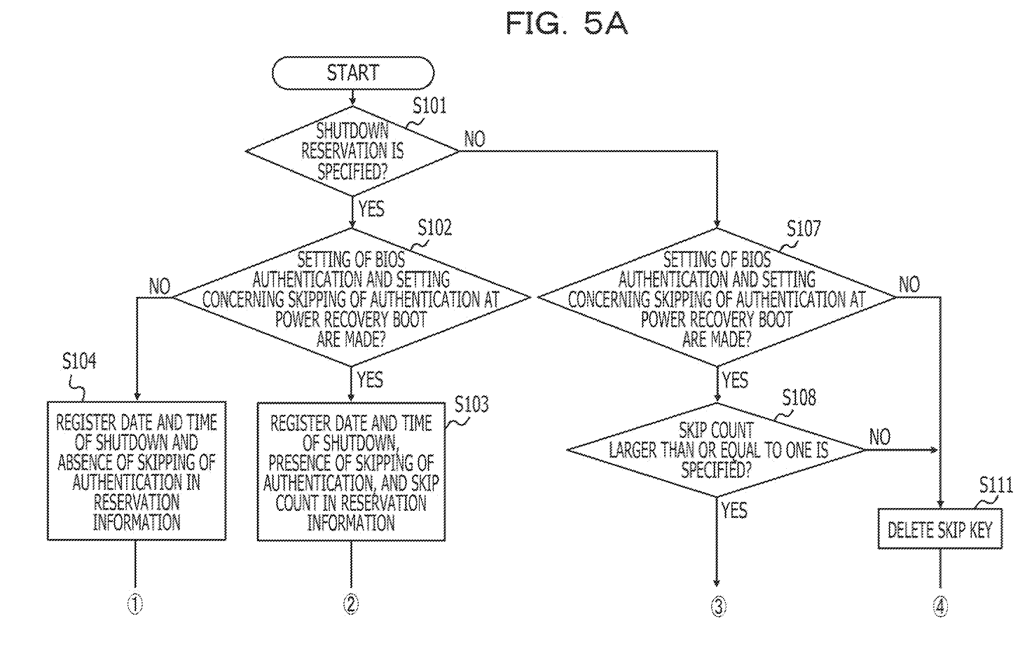

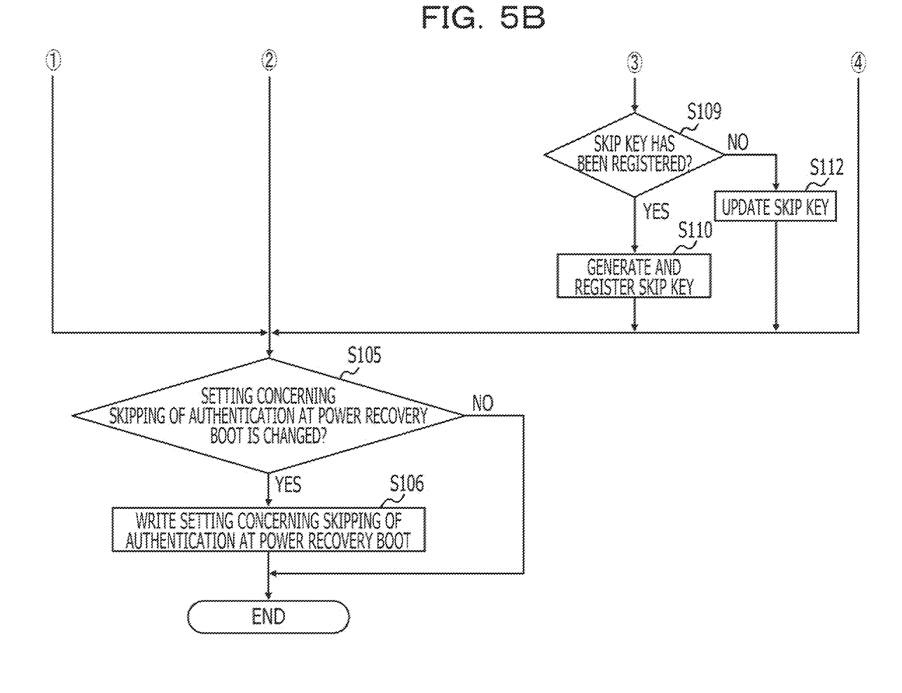

FIG. 5A and FIG. 5B illustrate a process performed by the information processing apparatus 1 in response to information input by the operator in accordance with the exemplary user interface in FIG. 4.

Referring to FIG. 5A, in Operation S101, it is determined whether the shutdown reservation is specified. Specifically, in the determination of the shutdown reservation, the authentication control information generator 21 determines whether the input information 123 specifies the shutdown reservation. If the input information 123 specifies the shutdown reservation (Yes in Operation S101), in Operation S102, it is determined whether the setting of the BIOS authentication and the setting concerning the skipping of the authentication at power recovery boot are made. Specifically, in the determination of the setting of the BIOS authentication, the authentication control information generator 21 confirms whether the BIOS authentication setting value 45 exits in the BIOS setup information 43. If the BIOS authentication setting value 45 indicating a password is stored in the flash ROM 4, the authentication control information generator 21 determines that the BIOS authentication at boot is set. In the determination of the setting concerning the skipping of the authentication at power recovery boot, the authentication control information generator 21 refers to the input information 123. If the input information 123 specifies the setting concerning the skipping of the authentication at power recovery boot, the authentication control information generator 21 determines that the skipping of the authentication at power recovery boot is set.

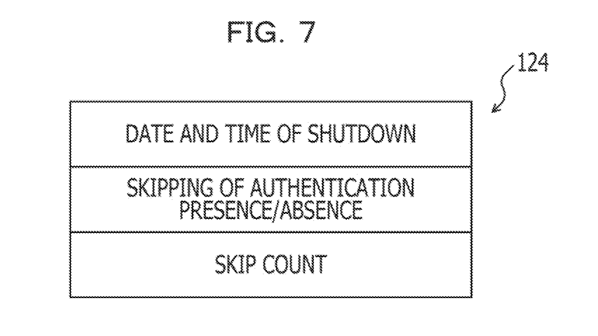

If the setting of the BIOS authentication and the setting concerning the skipping of the authentication at power recovery boot are made (YES in Operation S102), in Operation S103, the authentication control information generator 21 stores the reservation information 124 indicating the date and time of the shutdown, the presence of the skipping of the authentication, and the skip count in a specified area in the HDD 12. The reservation information 124 indicates, for example, a variety of information illustrated in FIG. 7. For example, the reservation information 124 indicates the date and time of the shutdown, the presence or absence of the skipping of the authentication at power recovery boot, and the skip count. Multiple sets of the reservation information 124: the date and time of the shutdown, the presence or absence of the skipping of the authentication at power recovery boot, and the skip count may be stored in the specified area.

If either the setting of the BIOS authentication or the setting concerning the skipping of the authentication at power recovery boot is not made (NO in Operation S102), in Operation S104, the authentication control information generator 21 stores the reservation information 124 indicating the date and time of the shutdown and the absence of the skipping of the authentication in the specified area.

After the reservation information 124 is stored in the specified area, in Operation S105, it is determined whether the setting concerning the skipping of the authentication at power recovery boot is changed. Specifically, in the determination of the setting concerning the skipping of the authentication at power recovery boot, the authentication control information generator 21 compares the presence or absence of the boot of the system at power recovery specified in the input information 123 with the boot information at power recovery 46 stored in the flash ROM 4. If the information indicated by the boot information at power recovery 46 does not coincide with the presence or absence of the boot of the system at power recovery specified in the input information 123, the authentication control information generator 21 determines that the setting concerning the skipping of the authentication at power recovery boot is changed. The authentication control information generator 21 also compares the presence or absence of the skipping of the authentication specified in the input information 123 with the authentication skip setting information 47 stored in the flash ROM 4. If the information indicated by the authentication skip setting information 47 does not coincide with the presence or absence of the skipping of the authentication specified in the input information 123, the authentication control information generator 21 determines that the setting concerning the skipping of the authentication at power recovery boot is changed.

If the authentication control information generator 21 determines that the setting concerning the skipping of the authentication at power recovery boot is changed (YES in Operation S105), in Operation S106, the authentication control information writer 22 changes at least one of the boot information at power recovery 46 and the authentication skip setting information 47 so as to reflect the input information 123. If the authentication control information generator 21 determines that the setting concerning the skipping of the authentication at power recovery boot is not changed (NO in Operation S105), the process in FIG. 5B is terminated.

If it is determined that the shutdown reservation is not specified (NO in Operation S101), in Operation S107, it is determined whether the setting of the BIOS authentication and the setting concerning the skipping of the authentication at power recovery boot are made. Specifically, in the determination of the setting of the BIOS authentication and the setting concerning the skipping of the authentication at power recovery boot, the authentication control information generator 21 refers to the BIOS authentication setting value 45 and the input information 123, as in Operation S102 described above. If the setting of the BIOS authentication and the setting concerning the skipping of the authentication at power recovery boot are made (YES in Operation S107), in Operation S108, it is determined whether the skip count that is larger than or equal to one is specified. Specifically, in the determination of the skip count, the authentication control information generator 21 refers to the skip count in the input information 123.

If either the setting of the BIOS authentication or the setting concerning the skipping of the authentication at power recovery boot is not made (NO in Operation S107), in Operation S111, the skip key deleter 26 deletes any skip key that is registered in the skip key registration area 44 in the flash ROM 4. Also if the skip count that is larger than or equal to one is not specified (NO in Operation S108), in Operation S111, the skip key deleter 26 deletes the skip key.

If the skip count that is larger than or equal to one is specified (YES in Operation S108), in Operation S109, it is determined whether the skip key has been registered in the flash ROM 4. If the skip key has not been registered in the flash ROM 4 (NO in Operation S109), in Operation S110, the skip key generator 23 generates a skip key and the skip key register 24 registers the generated skip key in the flash ROM 4. For example, when the input information 123 specifies the skip count that is equal to one, the skip key generator 23 generates a skip key “PWSKIP1.” When the input information 123 specifies the skip count that is equal to five, the skip key generator 23 generates a skip key “PWSKIP5.”

If the skip key has been registered in the skip key registration area 44 in the flash ROM 4 (YES in Operation S109), the authentication control information generator 21 compares the skip count specified in the input information 123 with the skip count indicated by the skip key registered in the skip key registration area 44. If the skip count specified in the input information 123 does not coincide with the skip count indicated by the skip key registered in the skip key registration area 44, the skip key generator 23 generates a new skip key based on the skip count specified in the input information 123. In Operation S112, the skip key register 24 overwrites the skip key registered in the skip key registration area 44 with the newly-generated skip key. Prior to the generation of a new skip key, the fact that the skip count specified in the input information 123 does not coincide with the skip count indicated by the skip key registered in the skip key registration area 44 may be indicated to the operator of the information processing apparatus 1.

Upon completion of the registration of the skip key (Operation S110) or completion of the update of the skip key (Operation S112), Operation S105 described above is performed.

The process in response to the pressing of the “Set” button in the user interface in FIG. 4 is performed in the above manner. The execution order of Operation S101 and Operation S102 may be appropriately changed. Similarly, the execution order of Operation S101, Operation S107, and Operation S108 may be appropriately changed. In addition, instead of the generation and storage of the reservation information 124, a task scheduler incorporated in Windows® of Microsoft® Corporation may be used.

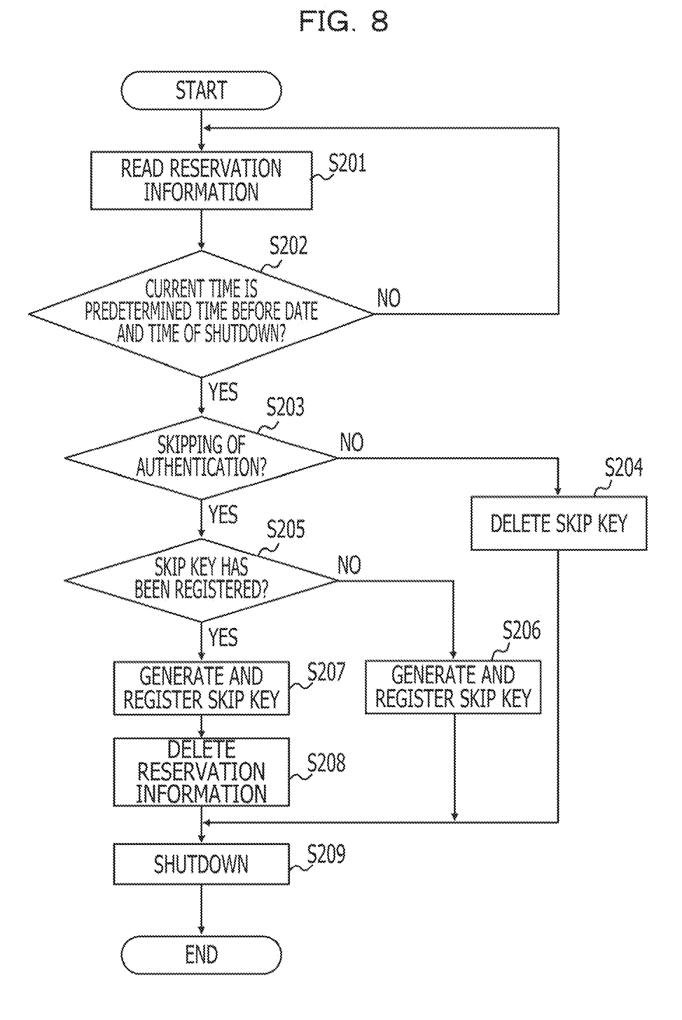

FIG. 8 illustrates a process of generating the authentication control information by using the reservation information 124 in FIG. 7. According to the present embodiment, the reservation information 124 is used by a resident application program. The resident application program is activated in conjunction with the boot of the information processing apparatus 1 and performs the generation of the authentication control information and the shutdown of the information processing apparatus 1 at a date and time of shutdown that is reserved.

Referring to FIG. 8, in Operation S201, the resident application program reads the reservation information 124 stored in the HDD 12. In Operation S202, the resident application program compares the date and time of shutdown in the reservation information 124 with the current time indicated by a timer incorporated in the information processing apparatus 1 to determine whether the current time is a specified time (for example, a few seconds) before the date and time of the shutdown in the reservation information 124. If the current time is not a specified time before the date and time of the shutdown in the reservation information 124 (NO in Operation S202), the resident application program performs S201 again.

If the current time is a specified time before the date and time of the shutdown in the reservation information 124 (YES in Operation S202), in Operation S203, the resident application program determines whether the reservation information 124 indicates the skipping of the authentication at power recovery boot. If the reservation information 124 indicates the absence of the skipping of the authentication at power recovery boot (NO in Operation S203), in Operation S204, the resident application program deletes any skip key that is registered in the skip key registration area 44 in the flash ROM 4. If the reservation information 124 indicates the presence of the skipping of the authentication at power recovery boot (YES in Operation S203), in Operation S205, it is determined whether the skip key has been registered in the skip key registration area 44 in the flash ROM 4.

If the skip key has been registered in the skip key registration area 44 in the flash ROM 4 (YES in Operation S205), the resident application program compares the skip count specified in the reservation information 124 with the skip count indicated by the skip key registered in the skip key registration area 44. If the skip count specified in the reservation information 124 does not coincide with the skip count indicated by the skip key registered in the skip key registration area 44, the resident application program generates a new skip key based on the skip count specified in the reservation information 124. In Operation S207, the resident application program overwrites the skip key registered in the skip key registration area 44 with the newly-generated skip key.

If the skip key has not been registered in the skip key registration area 44 in the flash ROM 4 (NO in Operation S205), in Operation S206, the resident application program generates a skip key and registers the generated skip key in the flash ROM 4. In Operation S208, the resident application program deletes the reservation information 124. Instead of the deletion of the reservation information 124, the resident application program may set a flag indicating that the authentication control information is generated based on the reservation information 124 in a certain area. Upon completion of the processing to the reservation information 124, in Operation S209, the resident application program shuts down the information processing apparatus 1.

The authentication control information is generated based on the reservation information 124 in the above manner. The operation of the resident application program described above is realized by the functional configuration illustrated in FIG. 2.

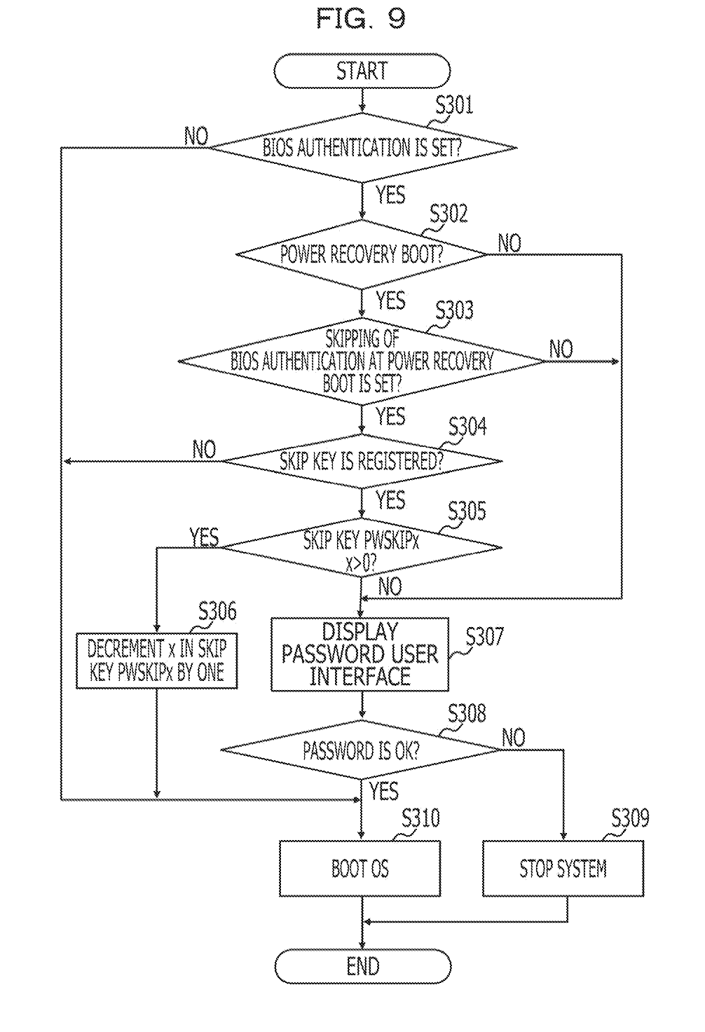

FIG. 9 illustrates an authentication control process according to the present embodiment.

Referring to FIG. 9, after the operating power is supplied to each component in the information processing apparatus 1 from the power unit 8, a process for booting the information processing apparatus 1 is started. In the present embodiment, the initialization program 42 in the BIOS 41 is activated. The initialization program 42 starts a process to initialize the hardware. In the initialization of the hardware by the initialization program 42, in Operation S301, it is determined whether the BIOS authentication is set. Specifically, in the determination of the setting of the BIOS authentication, the BIOS authentication setting determiner 31 refers to the BIOS setup information 43 in the flash ROM 4. If the BIOS authentication setting value 45 is registered in the BIOS setup information 43, the BIOS authentication setting determiner 31 determines that the BIOS authentication is set. As described above, the BIOS authentication setting value 45 is a password that is set in advance in the present embodiment. If the BIOS authentication setting value 45 is a null character, that is, if no password is set, the BIOS authentication setting determiner 31 determines that the BIOS authentication is not set (NO in Operation S301). In Operation S310, the OS booter 37 boots the OS 121.

If it is determined that the BIOS authentication is set (YES in Operation S301), in Operation S302, it is determined whether the boot trigger of the information processing apparatus 1 is the power recovery. Specifically, in the determination of the boot trigger of the information processing apparatus 1, the power recovery determiner 32 may use the function of the initialization program 42. For example, the power recovery determiner 32 determines whether the boot trigger of the information processing apparatus 1 is the power recovery, that is, whether the power recovery boot is performed based on the recognition of the boot with the AC recovery function of the initialization program 42. If it is determined that power recovery boot is performed (YES in Operation S302), in Operation S303, it is determined whether the skipping of the BIOS authentication at power recovery boot is set. Specifically, in the determination of the setting concerning the skipping of the BIOS authentication at power recovery boot, the authentication skip setting determiner 33 refers to the authentication skip setting information 47 in the BIOS setup information 43. The authentication skip setting determiner 33 determines whether the skipping of the BIOS authentication at power recovery boot is set based on the confirmation of whether the authentication skip setting information 47 indicates the skipping of the BIOS authentication.

If the skipping of the BIOS authentication at power recovery boot is set (YES in Operation S303), in Operation S304, it is determined whether the skip key exists. Specifically, in the determination of the presence or absence of the skip key, the skip key reader 34 refers to the flash ROM 4 to determine whether the skip key is registered in the flash ROM 4. If the skip key is not registered (NO in Operation S304), it is determined that the BIOS authentication is skipped without the skip count and, in Operation S310, the OS booter 37 boots the OS 121.

If the skip key is registered (YES in Operation S304), in Operation S305, it is determined whether the skip count specified by the skip key is one or more. If the skip count specified by the skip key is one or more (YES in Operation S305), in Operation S306, the skip key is updated so that the skip count specified by the skip key is decremented by one. If the skip count specified by the skip key is zero (NO in Operation S305), in Operation S307, a user interface for the BIOS authentication is displayed in the display unit 11. Specifically, a user interface prompting the operator of the information processing apparatus 1 to input a password is displayed in the display unit 11. In Operation S308, the BIOS authenticator 36 determines whether the password input by the operator with the keyboard 13 coincides with the BIOS authentication setting value 45. If the password coincides with the BIOS authentication setting value 45 (YES in Operation S308), the BIOS authenticator 36 determines that the authentication of the operator is successfully performed. In Operation S310, the OS booter 37 boots the OS 121.

If the password does not coincide with the BIOS authentication setting value 45 (NO in Operation S308), the BIOS authenticator 36 determines that the authentication of the operator is not successfully performed. In Operation S309, the boot of the information processing apparatus 1 is paused to stop the information processing apparatus 1. The input of the password by the operator may be performed a certain number of times.

If it is determined that the boot trigger of the information processing apparatus 1 is not the power recovery (NO in Operation S302) or if it is determined that the skipping of the BIOS authentication at power recovery boot is not set (NO in Operation S303), in Operation S307, the BIOS authenticator 36 performs the process for the BIOS authentication. Since the operations subsequent to Operation S307 are substantially the same as in the above processing, a description of the operations is omitted herein.

The skipping of the authentication process is realized a number of times of power recovery boot, desired by the operator, in the above manner.

The process of generating the authentication control information described above with reference to FIG. 8 may be performed in response to a command input by the operator. For example, the authentication control information may be generated in response to input of a command, such as “A:\>SKIP.EXE/shut 200901010800/skip on.” In the example, “/shutYYYYMMDDTTTT” indicates the date and time of the shutdown in a YYYYMMDDTTTT format. This example means that the shutdown is performed at 8:00 am on January first 2009. In the example, “/skip on” means that a process to skip the BIOS authentication is performed at shutdown.

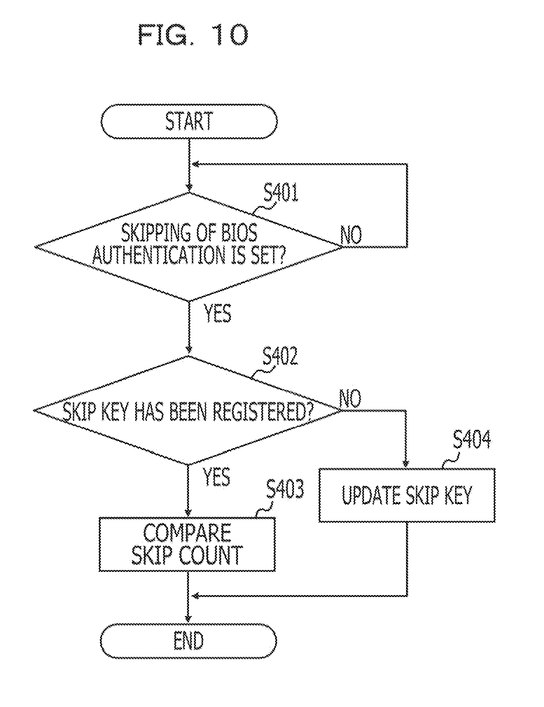

Alternatively, information used for skipping the BIOS authentication and the skip key may be set with the application program 122. In this case, for example, a process illustrated in FIG. 10 is performed.

Referring to FIG. 10, upon display of a specific user interface in the display unit 11 in a state in which the application program 122 is activated, in Operation S401, it is determined whether the skipping of the BIOS authentication is set. Specifically, in the determination of the skipping of the BIOS authentication, the authentication control information generator 21 determines that the skipping of the BIOS authentication is set (YES in Operation S401) if the skip count is specified by the operator in accordance with a certain user interface. The authentication control information generator 21 determines that the skipping of the BIOS authentication is not set (NO in Operation S401) unless the skip count is specified by the operator.

If the skip count is specified by the operator (YES in Operation S401), in Operation S402, it is determined whether the skip key has been registered in the flash ROM 4. If the skip key has not been registered in the flash ROM 4 (NO in Operation S402), in Operation S403, the skip key generator 23 generates a skip key and the skip key register 24 registers the generated skip key in the flash ROM 4.

If the skip key has been registered in the flash ROM 4 (YES in Operation S402), the authentication control information generator 21 compares the specified skip count with the skip count indicated by the skip key registered in the skip key registration area 44. If the specified skip count does not coincide with the skip count indicated by the skip key registered in the skip key registration area 44, the skip key generator 23 generates a new skip key based on the skip count specified in the input information 123. In Operation S404, the skip key register 24 overwrites the skip key registered in the skip key registration area 44 with the newly-generated skip key.

Although the BIOS authentication is applied to the authentication in the above embodiments, authentication other then the BIOS authentication may be applied. For example, biometric authentication including fingerprint authentication and vein authentication or authentication using a smart card may be applied.

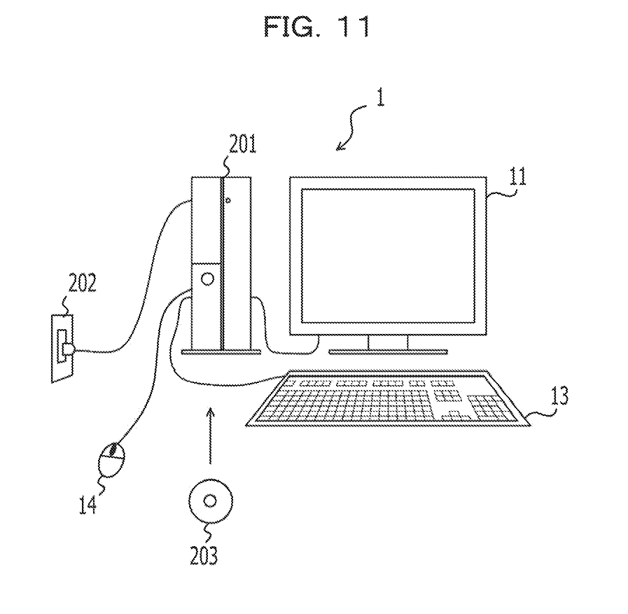

FIG. 11 illustrates an example of the external view of the information processing apparatus 1 described above. Referring to FIG. 11, the information processing apparatus 1 is realized by a desktop computer. The CPU 2 and the HDD 12 described above are housed in a casing 201. The information processing apparatus 1 includes a communication unit connected to a network, such as the Internet, via a cable connection part 202. The communication unit accesses an external database or the like to download a program, etc. stored in another computer system. A network communication card or a modem may be applied to such a communication unit. The information processing apparatus 1 includes a disk drive that reads and writes data from and in a portable recording medium, such as a disk 203.

The program performing the above processing may be provided as an authentication control program. The program is stored in a computer-readable recording medium to cause the information processing apparatus 1 to execute the program. The program executing the above operations is stored in a portable recording medium, such as the disk 203, or is downloaded from a recording medium of another computer via the communication unit. The authentication control program (authentication control software) causing the computer to have at least an authentication control function is input into the computer to be compiled. The authentication control program causes the computer to operate as the information processing apparatus having the authentication control function. The authentication control program may be stored in a computer-readable recording medium, such as the disk 203. The computer-readable recording medium is, for example, an internal storage unit, such as a ROM or a RAM, that is internally installed in the computer; a portable recording medium, such as the disk 203, a flexible disk, a digital versatile disk (DVD) disk, a magneto-optical disk, or an integrated circuit (IC) card; a database holding the computer program; another computer system and its database; or a recording medium that may be accessed from a computer system connected via a communication device, such as the communication unit.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. An information processing apparatus comprising:
a determining unit to determine whether a boot trigger of a boot is power recovery;
a memory to store count information indicating a skip count;
a booting unit to skip an authentication process depending on a result of a determination by the determining unit and the count information to continue the boot; and
an updating unit to update the count information when the authentication process is skipped.

2. The information processing apparatus according to claim 1, further comprising:
a reading unit to read the count information from the memory when the determining unit determines that the boot trigger is the power recovery.

3. The information processing apparatus according to claim 1, further comprising:
an authenticating unit to perform the authentication process when the authentication process is not skipped by the booting unit.

4. The information processing apparatus according to claim 1, further comprising:
wherein skip information indicating whether the authentication process is skipped is stored when the boot trigger is the power recovery, and
wherein the booting unit reads the count information when skipping of the authentication process is set and continues the boot when the skipping of the authentication process is not set.

5. The information processing apparatus according to claim 1,
wherein, in the authentication process performed by the authenticating unit, a basic input/output system in the information processing apparatus prompts an operator to input a password to compare the input password with a stored password.

6. The information processing apparatus according to claim 1, further comprising:
a generating unit to prompt an operator to input skip information when the information processing apparatus is shut down at a date and time input by the operator and to store the input count information in the memory.

7. A non-transitory computer-readable recording medium having a program recorded therein, the program causing a computer to execute a method, the method comprising:
determining whether a boot of the computer is at power recovery;
skipping an authentication process depending on a skip count indicated by count information read from a storage unit in the computer by a booting unit in the computer to continue the boot of the computer; and
updating the count information when the authentication process is skipped.

8. The recording medium according to claim 7, the method further comprising:
reading the count information from the storage unit when a determination is made that the boot is at power recovery.

9. The recording medium according to claim 7, the method further comprising:
performing the authentication process when the authentication process is not skipped by the booting unit.

10. The recording medium according to claim 7, the method further comprising:
determining whether the skipping of the authentication process is set when the boot is at power recovery;
reading the count information when the skipping of the authentication process is set; and
continuing the boot when the skipping of the authentication process is not set.

11. The recording medium according to claim 7, the method further comprising:
prompting an operator to input a password by a basic input/output system in the computer in the authentication process to compare the input password with a stored password.

12. The recording medium according to claim 7, the method further comprising:
prompting an operator to input skip information when the computer is shut down at a date and time input by the operator and storing the input count information in the storage unit.

13. A method of controlling an authentication process, the method being executed by a computer and comprising:
determining whether a boot of the computer at power recovery;
skipping an authentication process depending on a skip count indicated by count information read from a storage unit in the computer by a booting unit in the computer to continue the boot of the computer; and
updating the count information when the authentication process is skipped.

14. The method of controlling an authentication process according to claim 13, further comprising:
reading the count information from the storage unit when a determination is made that the boot is at power recovery.

15. The method of controlling an authentication process according to claim 13, further comprising:
performing the authentication process when the authentication process is not skipped by the booting unit.

16. The method of controlling an authentication process according to claim 13, further comprising:
determining whether the skipping of the authentication process is set when the boot is at power recovery;
reading the count information when the skipping of the authentication process is set; and
continuing the boot when the skipping of the authentication process is not set.

17. The method of controlling an authentication process according to claim 13, further comprising:
prompting an operator to input a password by a basic input/output system in the computer in the authentication process to compare the input password with a stored password.

18. The method of controlling an authentication process according to claim 13, further comprising:
prompting an operator to input skip information when the computer is shut down at a date and time input by the operator and storing the input count information in the storage unit.
